(19) United States
(12) Patent Application Publication
(10) Pub. No.: US 2006/0109855 A1
(43) Pub. Date: May 25, 2006

(54) Ring network for a burst switching network with centralized management

(75) Inventor: Miguel De Vega Rodrigo, Brussels (BE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/269,006

(22) Filed: Nov. 8, 2005

(30) Foreign Application Priority Data
Nov. 9, 2004 (EP) EP04026558

(51) Int. Cl. H04L 12/28

(52) U.S. Cl. 370/404

(57) ABSTRACT

A ring network that transmits bursts and data packets is provided. In one embodiment, setup message is sent from a node i to a central node to set up communication between the node i and a node j. The central node stops a current transmission on a path between the node i and a node j that transmits bursts and data packets when the current transmission of the path transmits data packets. The central node ( establishes the communication between the node i and the node j along the path.

### CROSS REFERENCE TO RELATED APPLICATIONS

This application claims priority of European application No. 04026558.9 EP filed Nov. 9. 2004. which is incorporated by reference herein in its entirety.

### FIELD OF INVENTION

The present invention relates to transmitting data in a ring in a network as a combination of reserved bandwidth bursts and IP packets that are sent on-the-fly and, more particularly, to an Adaptive Burst Switching Optical Network (APSON) APSON.

### BACKGROUND OF INVENTION

APSON may be thought of as a hybrid network technology between Optical Burst Switching (OBS) and ASON (Automatic Switched Optical Networks). This will be appreciated from FIG. 1 which shows the three transport networks 100 side-by-side.

In OBS networks 102, the bandwidth 104 associated to this path is reserved as long as the path is not torn down, which basically means that these bandwidth resources are not available to other sources. In other words, the transmitted data is protected as long as the path exists.

It is important to note, however, that in OBS networks, only the bandwidth equivalent to the duration of the burst is reserved. If another burst wishes to be transferred before this protected data time gap is over, i.e., before the current burst has been transmitted, it will be blocked. In addition, in OBS networks no information can be sent between bursts as shown by the wasted bandwidth section 106.

In ASON (108, FIG. 1), data is sent as it arrives, i.e., “on-the-fly” through an established path. The data is normally IP packets 110 and the bandwidth is not reserved. Naturally, this means that ASON is more flexible than OBS, which makes it easier to implement Quality of Service (QoS) rules for treating different customers differently. On the other hand, ASON is not structured and is more difficult to control than OBS.

In APSON 112, the duration of the reserved bandwidth, i.e., the duration of the protected data 114, is detached from the duration of a burst transmission 116. In other words, the APSON scheme is both λ-switching regime and an unprotected data time gap, wherein the bursts are transmitted under a protected transmission while the IP packets that are sent on-the-fly are transmitted, either protected or unprotected, in the λ-switching. This allows for more flexibility when implementing different quality of service (QoS) to different customers based on, for example, customer plans.

### SUMMARY OF THE INVENTION

There are similarities between APSON and these previous networks, however, APSON is really a unique network scheme. Prior to the creation of a new lightpath, for example, packets are collected in an aggregation buffer. This is somewhat similar to OBS networks. Some other concepts were borrowed from OBS networks as well, such as the OBS bandwidth reservation scheme. However, APSON is distinctly different than OBS. Most significantly, APSON effectuates a circuit switching philosophy similar to ASON, whilst OBS networks use a packet switching approach. Thus, APSON, while a hybrid of the two network philosophies, is a completely different type of network.

Because APSON is a brand new switching scheme, it has not yet been discussed in the field how to provide a ring topology for APSON. However, it would be advantageous to provide a ring topology to APSON because rings are simple to implement and, for this reason, have historically played an important role in optical networks. For instance, routing, switching and network management tasks are considerably less complex in ring topologies in comparison to meshed topologies. For this reason, rings would be a highly desirable topology for deploying new optical network technologies such as APSON.

The invention aims at providing the basic concepts for the deployment of a simple, yet, highly efficient centralized APSON. In providing a viable centralized approach, special consideration is given to the current technological limitations at the optical layer, such, for example, the switching speed.

Ring topologies have been widely studied in X-switching networks. More recently, OBS ring networks have re-awakened the interest of the research community and this has resulted in many more-recent studies investigating the performance of rings in light of switching networks. Studies, such as A. Zapata, I. de Miguel, M. Düiser, J. Spencer, P. Bayvel, D. Breuer, N. Hanik, and A. Gladisch. Performance comparison of static and dynamic optical metro ring network architectures. Proceedings ECOC 2003, have suggested that the most promising architecture in terms of delay, network throughput and the number of wavelengths needed is not OBS but, rather, a variant of OBS called Wavelength Routed OBS networks (WR-OBS). Apparently, the difference is that the source in OBS networks sends a header packet and, after waiting an offset time, sends the burst as well. In WR-OBS networks, by contrast, the source sends a header packet but it waits for an acknowledgement from the network before sending the burst.

The fact that “Zapata” and similar studies point out that WR-OBS networks are the most promising architecture for optical ring networks is hopeful news for APSON. APSON uses a similar acknowledgement-based variant of OBS signalling in order to setup a lightpath. However, it is not yet known for certain whether a ring topology would be as advantageous for APSON. Nor is it certain or defined how a ring topology would be applied for APSON.

To date, there has been no concept for a centralized APSON ring defined. However, encouraging studies such as Zapata's is motivating. It would, therefore, be advantageous to find a viable and efficient APSON-based ring solution. Such a solution should, in theory, have even better results than in the ring WR-OBS architecture since APSON has advantages in comparison to OBS-based solutions like WR-OBS networks.

For one thing, an APSON ring topology would be able to reuse the standardized ASON control plane. Moreover, an APSON ring would be easier and quicker to deploy due to fewer technological challenges. An APSON ring would also offer less delay, higher throughput, lower signalling overhead and self-organizing architecture.

APSON-based rings present advantages also in comparison to λ-switching approaches. In a pure all-optical λ-switching rings with N nodes, each node requires a channel in order to receive data from the rest of the nodes. Therefore, a total of M=N−1 channels are needed. Due to the fact that APSON presents time multiplexing of bandwidth resources, the number of wavelengths needed will be reduced compared to the λ-switching case.

To explain, if multimode fibers are being used, a channel would represent a wavelength in one of the fibers. But, it must be remembered that a channel is a concept at the logical layer. If monomode fibers are being used, a channel would directly represent one of the fibers. At any rate, the mapping between channels and wavelengths (between logical and physical layer) can be easily achieved according to the type of optical fiber being used (mono- vs. multimode) and whether λ-conversion capabilities are available. With λ-conversion capabilities the number of wavelengths W needed is W=M. In our discussion λ-conversion is not available so the number of wavelengths needed is W=M +1=N, be it in a mono- or multimode fiber.

In APSON, the multiplexing clearly reduces the number of wavelengths needed dramatically. Moreover, there is always a number of optical components associated with each wavelength. Some of these optical components, such as tunable lasers, are quite expensive. Therefore, the reduction in the number of wavelengths needed has a great impact on cost, which is a main motivation for the invention to propose and research the effectiveness of APSON rings. Heretofore, there has been no application of a ring topology to APSON.

However, the motivation to develop an APSON ring topology belies the following problem. Nowadays, commercially available switching fabrics offer switching speeds usually in the order of milliseconds. This leads to path setup times in the order of seconds, sometimes longer, which is clearly not fast enough for a truly dynamic switching architecture with link capacities in the order of Gbps. With the current switching speeds, every time a new path setup takes place, a non-negligible amount of bandwidth is wasted. This increases the blocking probability, which leads to the need of a higher number of wavelengths and their associated expensive optical hardware, such as tunable lasers. Therefore, the slower the switching fabric and the higher the number of path setups per unit of time the higher the costs in optical hardware. This presents at least one major obstacle to be overcome in order to implement dynamic switching architectures such as ASON, APSON or, for that matter, OBS.

In order to reduce hardware costs either faster low-cost switching fabric should be produced or an optical solution that reduces the number of switching actions per unit of time should be used. The first possibility is at present an unlikely solution given the limitations in current technology. The invention focuses on the second alternative to provide a viable ring topology solution for APSON.

The present invention provides a feasible centralized APSON ring with present-day optical components without sacrificing high network performance.

A method for transmitting data in a ring network that transmits bursts and data packets, characterized in that, sending a setup message from a node i (204ᵢ) to a central node (202) to set up communication between the node i (204ᵢ) and a node j (204ⱼ), stopping a current transmission on a path between the node i (204ᵢ) and a node j (204ⱼ) that transmits bursts and data packets when the current transmission of the path transmits data packets, and establishing the communication between the node i (204ᵢ) and the node j (204ⱼ) along the path.

A system for a ring network that transmits bursts and data packets sent, characterized in that, a node i for sending a setup message to set up a communication between the node i and a node j along a path that transmits a combination of bursts over reserved bandwidth and data packets, a central node (202) for stopping a current transmission of the path when the current transmission of the path transmits data packets, and wherein, the central node (202) establishes the data flow between the node i and the node j along the path.

It shall be appreciated that, since the present invention makes use of APSON, the number of switching actions per unit of time is reduced to zero, or substantially zero, or otherwise reducing, the number of switching actions per unit of time inside the ring network.

In one aspect, and in order to reduce costs and to make the concept feasible with the optical technologies of today, no X-conversion capabilities inside the ring network will be used.

In another aspect, and in order to reduce costs and to make the concept feasible with the optical technologies of today, no dynamic switching inside the ring network will be used.

### BRIEF DESCRIPTION OF THE DRAWINGS

The drawings illustrate at least one example of the invention, wherein:

FIG. 1 shows various transport schemes;

FIG. 2 shows a schematic diagram of the present invention;

FIG. 3 shows the present invention in terms of functional description; and

FIG. 4 shows a variation of the present invention.

### DETAILED DESCRIPTION OF THE PREFERRED EMBODIMENTS

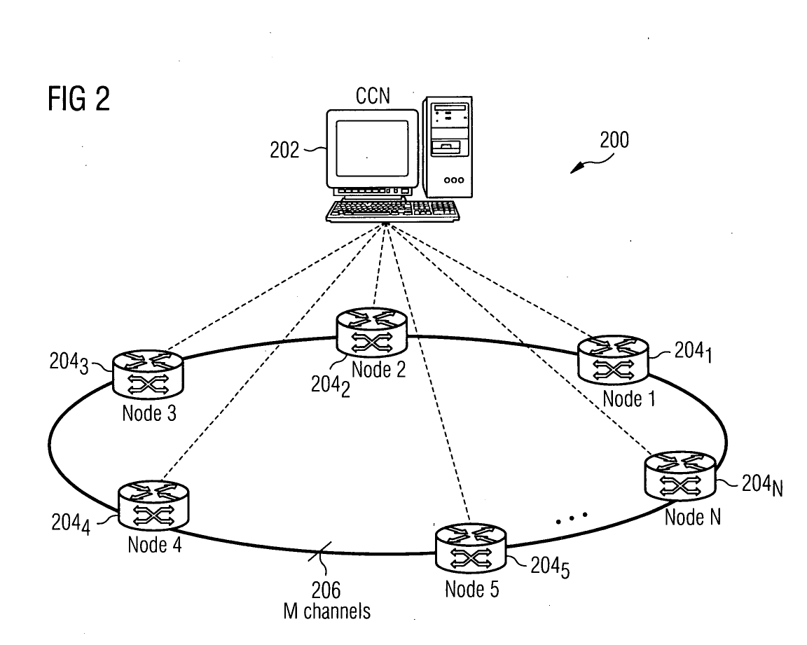

In a centralized APSON architecture 200 shown in FIG. 2, a central node (CCN) 202 is in charge of coordinating network signalling tasks such as path setup and teardowns. In contrast, in a de-centralized APSON architecture signalling messages are exchanged among network nodes without the need for a central node to coordinate them. This invention report presents an APSON ring concept based on a centralized APSON architecture.

In the Figure, it is assumed that the centralized ring APSON architecture includes N nodes 204, . . . in and M channels 206. It should be kept in mind that FIG. 2 is a simplified diagram, and the details of the ring network are not described owing to the well-known literature. One point that should be bourn in mind, however, that is not shown is that, if multimode fibers are being used a channel represents a wavelength in one of the fibers. On the other hand, if monomode fibers are being used a channel directly represents one of the fibers.

Due to the fact that APSON provider time multiplexing of the wavelength capacities, the number of channels in the present invention will typically be below the number of nodes (M≦V). This is a main advantage in comparison to λ-switching networks Without λ-conversion, an APSON data flow (composed by a burst and possibly IP packets) uses the same wavelength along its path.

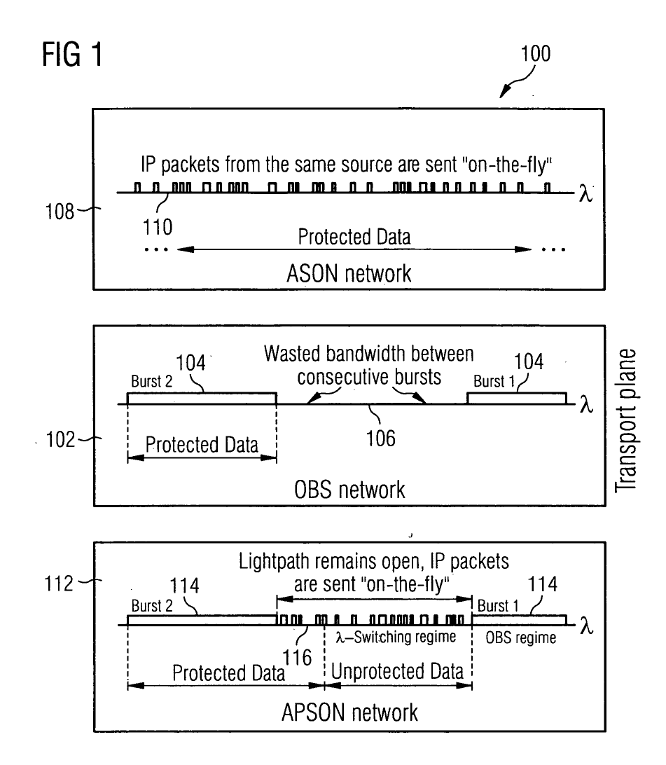

Without the luxury of dynamic switching, an APSON data flow uses the same fixed combination of fibers along its path. This means at the logical layer (see FIG. 1) that the APSON data flow, once established in channel i, cannot switch to another channel j (with i≠j).

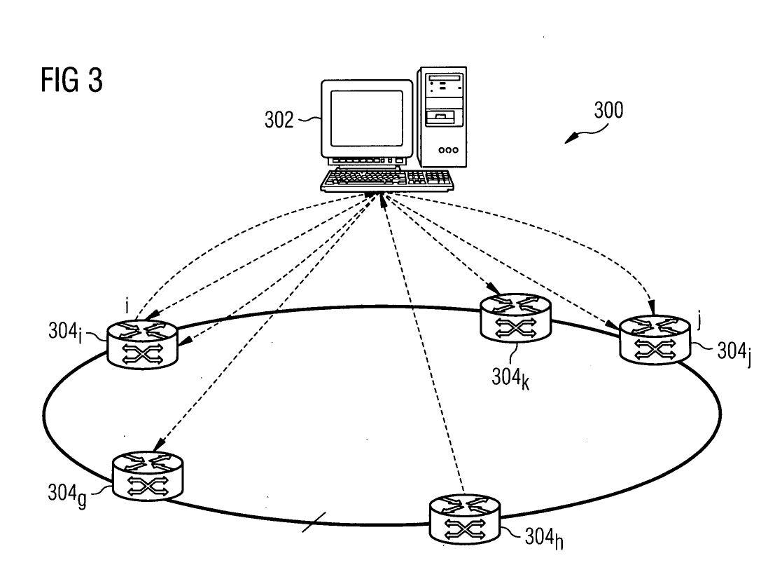

A functional description of the centralized ring APSON 300 will now be described with reference to FIG. 3. In order for node i 304 to send a data flow to node j 304s the following steps are provided by the invention preferably, in the following order.

In a first step, each node (304, 304s) receives incoming IP packets, sorts them according to their destination and collects them in different electrical buffers, each one for each destination. Node i 304, sends a path setup message to the CCN 302 whenever an algorithm called the “aggregation strategy” decides that enough packets for destination j 304, have been collected in the corresponding electrical buffer.

In another step, the CCN 302 determines according to a predetermined algorithm that determines the best end-to-end path between i and j (304, 304) according to some performance criteria such as the path availability. When the path is chosen, a stop message is sent to the source and destination nodes, for example, g and h (304g, 304ₕ) using it, in order to allocate its bandwidth resources for the transmission between i and j (for more details on this process see the fifth step below).

In a further step, the CCN 302 sends a send message to the edge node i 304, whenever the end-to-end path becomes available and its bandwidth resources have been allocated. When the edge node i 304, receives the send message it begins to transfer the data flow on the wavelength and/or optical fiber indicated in the message.

In an additional step 4, the CCN 302 sends a receive message to node j 304j, synchronized with the arrival of the data flow from i 304 informing about the wavelength and/or optical fiber on which the flow arrives. With this information node j 304j, listens at the indicated wavelength and fiber converting the information it receives to the electrical domain and so recovering the data sent by node i 304i. Otherwise, if a node does not receive the receive message it forwards it without optical-electrical conversion to take place. In this manner, the present invention ensures that the data plane remains all-optical.

In another step, the resource allocation is accomplished. When a data flow from another node k 304k interrupts the transmission of the data flow from node i to j (304i, 304j), bandwidth resources for the data flow from node k (304k) are allocated. In this aspect of the invention, nodes i and j (304i, 304j) receive a stop message from the CCN indicating that the transmission and reception on the indicated wavelength and/or optical fiber must cease. For node j (304j) this means that the optical-electrical conversion from the photons received on the indicated wavelength and/or optical fiber is stopped.

The conditions for the flow interruption to take place may be explained as follows. In a data flow bandwidth is reserved for the transmission of the first t_{flow} seconds, whereas the rest of the bits of the flow have no bandwidth reservation. This means that another data flow can interrupt the transmission of the current data flow if and only if more than t_{flow} seconds have passed since the beginning of the flow transmission.

In an alternative solution, the CCN 302 is released partially from its complexity which in turn relies on the edge nodes. In this manner, in the third and fifth steps set forth above the sending of the messages send and receive does not need to be synchronized with the transmission and arrival of the first bit of the data flow. In this case, the messages are sent before with an extra field indicating the time until the transmission or arrival of the first bit. Nodes i and j (304i, 304j) are equipped with a timer so that they can automatically begin the transmission or reception of the photons on the specified wavelength and/or optical fiber when the timer is triggered. The timer is set according to the value contained in the extra field of the send or receive messages.

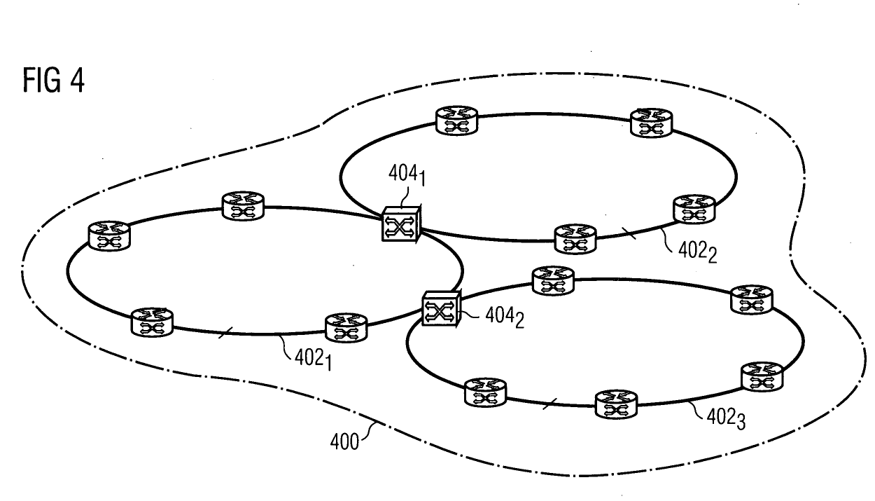

FIG. 4 illustrates an example of a possible APSON architecture 400 made from three APSON rings 402₁-402₃ interconnected through two Hubs 404₁, 404₂. It shall be appreciated from FIG. 3 that the invention is also portable to any number of rings in the ring topology. The invention provides the functionality discussed above for each ring assuring that, for traffic inside each ring, no switching takes place. This provides all of the advantages derived from APSON at a low cost with present-day optical components.

If the different rings of FIG. 4 are kept as independent APSON rings, for traffic coming from one ring and going to another ring, either OEO (opto-electro-optic) conversion or dynamic switching must take place (at the hubs). On the other hand, one could operate consider the three rings as one single ring (see FIG. 3), in which case the need for OEO in the transport plane or dynamic switching would disappear.

The new Centralized APSON Ring concept of the present invention is advantageous. The solution is valid for both uni- and bidirectional links, and a short routing information (for instance a flag bit 1 or 0) can be easily added in an extra field of the send message in order to indicate the source node whether to send the data flow through the optical fiber on the left or on the right. Due to the efficient wavelength time multiplexing of APSON the number of wavelengths for a given ring topology and given offered traffic volume is reduced in comparison to WR-OBS, OBS and especially to λ-switching networks. Further, each wavelength has associated several optical components, some of which are quite expensive such as the tuneable lasers. Reducing the number of wavelengths means important cost savings on optical components that are no longer needed.

Again, due to the fact that APSON presents the most efficient wavelength time multiplexing in comparison to WR-OBS, OBS architectures, a centralized APSON ring offers a lower delay, delay jitter that their OBS-based counterparts. For the same reason, the blocking probability in centralized APSON rings is virtually zero. The concept allows for QoS implementations and provides an all-optical transport plane. Furthermore, the concept allows to share complexity between the central control node (CCN) and the optical nodes according to the needs or to the hardware requirements (see the fifth step, for example. In addition, switching can be eliminated. As a consequence of this the switching speed of the switching fabric does not play an important role anymore, which allows for a direct cost reduction. Nor does the invention require λ-conversion. For these and other reasons, a centralized APSON ring is an extremely efficient architecture and yet feasible at a low cost with nowadays optical components.

1.-14. (canceled)

15. A method for transmitting data in a ring network that transmits bursts and data packets over a particular path, comprising:
sending a setup message from a first node to a central node to set up communication between the first node and a second node;
stopping a current transmission on a path that transmits bursts or data packets between the first node and the second node when the current transmission transmits data packets over the path; and
establishing the communication between the first node and the second node along the path.

16. The method according to claim 15, further comprising sending a send message from the central node to the first node that indicates the path that is to establish the communication between the first node and the second node.

17. The method according to claim 16, further comprising sending a message to the second node that indicates the path that is to establish the data flow between the first node and the second node.

18. The method according to claim 17, further comprising:
detecting by the second node at the indicated wavelength and fiber, converting the information it receives to the electrical domain, and recovering the data sent by first node.

19. The method according to claim 18, further comprising:
receiving incoming IP packets,
sorting the IP packets according to destination, and
collecting the IP packets for each destination.

20. The method according to claim 19, further comprising determining a best end-to-end path between first node and second node according to a performance criteria.

21. The method according to claim 20, further comprising allocating bandwidth resources for the data flow from a third node when a data flow from the third node interrupts the transmission of the data flow from first node to a fourth node.

22. A system for a ring network that transmits bursts and data packets sent over a particular path, comprising:
a first node for sending a setup message to set up a communication between the first node and a second node along a path that transmits bursts over reserved bandwidth or data packets; and
a central node for stopping a current transmission of the path when the current transmission transmits data packets over the path, wherein, the central node establishes the data flow between the first node and the second node along the path.

23. The system according to claim 22, wherein the central node multiplexes wavelength capacities of M channels of the ring network in order that the number of channels is significantly below a number of nodes in the ring network.

24. The system according to claim 23 wherein multimode fibers are used to transmit data in the centralized ring and a channel represents a wavelength in one of the fibers.

25. The system according to claim 23, wherein monomode fibers are used to transmit data in the centralized ring a channel directly represents one of the fibers.

26. The system according claim 23, wherein the centralized ring transmits data without X-conversion.

27. The system according to claim 23, wherein the centralized ring transmits data without dynamic switching.

28. The system according to claim 22, further comprising multiple rings of a type of the ring network that are interconnected through Hubs.

29. A method for path management by a central node in a ring Adaptive Burst Switching Optical Network, comprising:
receiving a path setup message from a first node to set up a path between the first node and a destination node;
determining a path between the first node and the destination mode;
sending a send message that includes a path indicator, which indicates the path, to the first node, the send message indicates to start a transmission by the first node to the destination node via the path; the path includes a indicator selected from the group consisting of a wavelength, a optical fiber, and combinations thereof; and
sending a stop message to the first node to stop the transmission

30. The method according to claim 29, wherein the send message includes a first value to indicate to the first node a time to wait before starting the transmission.

31. The method according to claim 30, further comprises sending a receive message having the path to the destination mode, the receive message indicates to start expecting the transmission by the first node via the path.

32. The method according to claim 31, wherein the receive message includes a second value to indicate to the destination node a time to wait before expecting to receive the transmission.
